(19) United States
(12) Patent Application Publication
(10) Pub. No.: US 2014/0246419 A1
(43) Pub. Date: Sep. 4, 2014

(54) Top-browner cooking system for electric roasting ovens and method of use

(71) Applicant: George T.C. Li, Reno, NV (US)

(72) Inventor: George T.C. Li, Reno, NV (US)

(21) Appl. No.: 13/815,446

(22) Filed: Mar. 4, 2013

(51) Int. Cl. F24C 7/06; B23P 11/00

(52) U.S. Cl. CPC F24C 7/062; B23P 11/00
USPC 219/395; 219/403; 29/428; 219/417

(57) ABSTRACT

A top-browner cooking system and method of use for browning chicken, turkey and other foodstuffs within electric roasting ovens that lack top-browning capability is disclosed. The present top-browner cooking system provides a plurality of top-browner assemblies which are configured for retrofitting to various sizes and shapes of common prior art roasting ovens lacking a top-browner heating element as original equipment. In addition to retrofitting a preexisting roasting oven, the top-browner cooking system is also utilized in combination with roasting ovens of new construction. The top-browner cooking system is designed for stand-alone use being plugged directly into a residential power outlet or, alternatively, can be plugged into an auxiliary power outlet provided on some brands of roasting ovens. The top-browner assemblies of the present cooking system are provided with detachable power cords including an electromechanical power switch or, alternatively, a multi-position switch for the convenience of the user.

### BACKGROUND OF INVENTION

The present invention relates to cooking appliances and, more particularly, to a stand-alone, top-browner cooking system and method of use for browning chicken, turkey and other foodstuffs while cooking within a preexisting roasting oven having a heating element for applying heat to the sides of such a cooking vessel.

Electric cooking pots for preparing and serving hot foods of the type sold under the trade names, CROCK POT®, RIVAL®, CUISINART® and other brands are well known to those skilled in the art. Such electric cooking pots typically include a wrap-around type heating element for applying heat to the sides of the cooking vessel or, alternatively, a bottom heating element arranged in functional relation to the bottom of the cooking well for supplying heat for cooking. Such cooking wells are often constructed of aluminum, stainless steel or enameled steel for reasons of durability and sanitation. However, it is known that both stainless steel and enameled steel have relatively low coefficients of heat conductivity as compared with other metals.

This presents a particular problem for cooking vessels of large capacity (i.e. up to 26 quarts). Applying heat only to the bottom or sides of such a large capacity cooking vessel, especially when constructed of stainless steel or enameled steel, can result in the upper portion of the cooking vessel being insufficiently heated. Thus, the food in the upper portion of the cooking vessel may be insufficiently cooked for serving purposes due to the loss of heat in combination with the low rate of heat conductivity and the slow rate at which heat is supplied to the upper portion of the cooking vessel. Often such a cooking vessel lacks top-browning (i.e. to scorch lightly) capability, which is desirable when cooking chicken, turkey or other foodstuffs.

The heat distribution problem is compounded in a roasting oven of large capacity and cannot be resolved by simply increasing the power output of the heating elements. This is due to the fact that the increased heater output tends to overcook the sides and bottom of the food item before the top of the food can turn brown. Thus, the present top-browner cooking system for such a roasting oven has been developed to solve these problems and other shortcomings of the prior art.

### DESCRIPTION OF THE PRIOR ART

U.S. Pat. No. 7,012,221 issued on Mar. 14, 2006, entitled Roasting Oven With Dual Heating Elements, by the same inventor named herein, discloses a roasting oven in which an integrated lid member including a top heating element is attached to the oven by electrically conductive supporting structures. Such roasting oven incorporates the circuitry and components for the top-heating element. However, the top-heating element of this patent is not designed for stand-alone use and lacks other advantages of the present invention.

U.S. Pat. No. 6,884,971 issued on Apr. 26, 2005, entitled Roasting Oven With Dual Heating Elements,” by the same inventor named herein, while different from the present invention, includes information that may be helpful in understanding the advantages of the present invention.

U.S. Pat. No. 6,867,394 issued on Mar. 15, 2005, entitled Roasting Oven With Dual Heating Elements,” by the same inventor named herein, while different from the present invention, includes information that may be helpful in understanding the advantages of the present invention.

U.S. Pat. No. 6,686,569 issued on Feb. 3, 2004, entitled Roasting Oven With Dual Heating Elements,” by the same inventor named herein, while different from the present invention, includes information that may be helpful in understanding the advantages of the present invention.

U.S. Pat. No. 6,509,550 issued on Jan. 21, 2003, entitled Roasting Oven With Dual Heating Elements,” by the same inventor named herein, while different from the present invention, includes information that may be helpful in understanding the advantages of the present invention.

Thus, the present invention has been developed to provide a stand-alone, top-browner cooking system for browning chicken, turkey and other foodstuffs for use in combination with a prior art roasting oven having integrated heating elements for applying heat to the side, bottom or both the sides and bottom of such a cooking vessel. The present invention also provides a method of retrofitting a top-browner assembly to a prior art roasting oven, which does not otherwise provide top-browning capability.

### SUMMARY OF THE INVENTION

Accordingly, the present invention provides a top-browner cooking system and method of use for browning chicken, turkey and other foodstuffs for cooking within a roasting oven having preexisting heating elements for applying heat to at least the sides and, alternatively, the bottom of such a roasting oven, but which does not provide a top-browner heating element for browning (i.e. to scorch slightly in cooking).

The present invention provides a stand-alone, top-brown cooking system including a top-browner assembly having a browning element which is configured to be mounted on the inner surface of a replacement lid member. In one embodiment a tubular heating element of the type sold under the trade name, CAL-ROD®, provides the browning function. In this embodiment the replacement oven lid is fabricated from heatproof glass, metal or other suitable material. The top-browning element extends through such replacement lid within an insulating block having a plug connector for attachment to an electrical outlet. In alternative embodiments of the present invention, other types of heating elements such as infrared, halogen, die cast or mica heaters can be employed.

Advantageously, the present top-browner cooking system is provided with a detachable power cord including an electromechanical ON/OFF switch, which can be removed from the lid for cleaning and storage. Alternatively, a multi-position (i.e. LOW, MEDIUM, and HIGH) step-switch or a rheostat type switch can be provided for the user's convenience. The present top-browner cooking system is designed to be plugged directly into a residential electrical outlet or, alternatively, can be plugged into an auxiliary AC outlet provided on the present oven.

In alternative embodiments of the present cooking system, the top-browner assemblies of the present cooking system are configured to fit various common sizes and shapes of commercially available roasting ovens and are suitable for retrofitting to such ovens to permanently replace the original factory lid.

Other features and technical advantages of the present invention will become apparent from a study of the following description and the accompanying drawings.

### BRIEF DESCRIPTION OF THE DRAWINGS

The novel features of the present invention are set forth in the appended claims. The invention itself, however, as well as other features and advantages thereof will be best understood by reference to the following detailed description of an illustrative embodiment when read in conjunction with the accompanying figures wherein:

FIG. 1A is a front elevation view of a prior art roasting oven and is labeled PRIOR ART;

FIG. 1B is a composite front elevation view of the prior art roasting oven of FIG. 1A showing the lid removed and rotated 90 degrees from the position shown in FIG. 1A and is labeled PRIOR ART;

FIG. 2 is a top plan view of the of the prior art roasting oven of FIG. 1B and is labeled PRIOR ART;

FIG. 3 is a top perspective view of one embodiment of a top-browner assembly of the present cooking system wherein a replacement lid member is rectangular in configuration;

FIG. 4 is a bottom perspective view of the top-browner assembly of FIG. 3 showing further details thereof;

FIG. 5 is a transverse cross-section of the top-browner assembly illustrated in FIGS. 3 and 4 showing further details thereof;

FIG. 6 is a perspective view of the top-browner assembly shown in FIGS. 3 and 4 of the present cooking system shown installed on the prior art roasting oven of FIG. 2 in replacement of the original lid;

FIG. 7 is a bottom perspective of an alternative embodiment of a top-browner assembly of the present cooking system wherein a replacement lid member is oval in configuration;

FIG. 8 is a top perspective view of an alternative embodiment of a top-browner assembly of the present cooking system;

FIG. 9 is a composite perspective view of the top-browner assembly of FIG. 8 showing the browning element removed from the lid member;

FIG. 10 is a transverse cross-section of the top-browner assembly of FIG. 8 showing further details thereof;

FIG. 11 is a top perspective view of a roasting oven including the detachable top-browner assembly of FIG. 8 installed thereon; and

FIG. 12 is a partial longitudinal cross-section of the roasting oven of FIG. 11 showing further details thereof.

### DETAILED DESCRIPTION OF THE PREFERRED EMBODIMENTS

The following description is presented to enable any person skilled in the art to make and use the present invention, and is provided in the context of a particular application and its requirements. Prior to describing the present invention in detail, it may be beneficial to briefly review the structure and function of an electric roasting oven of the prior art wherein the present top-browner cooking system will be utilized.

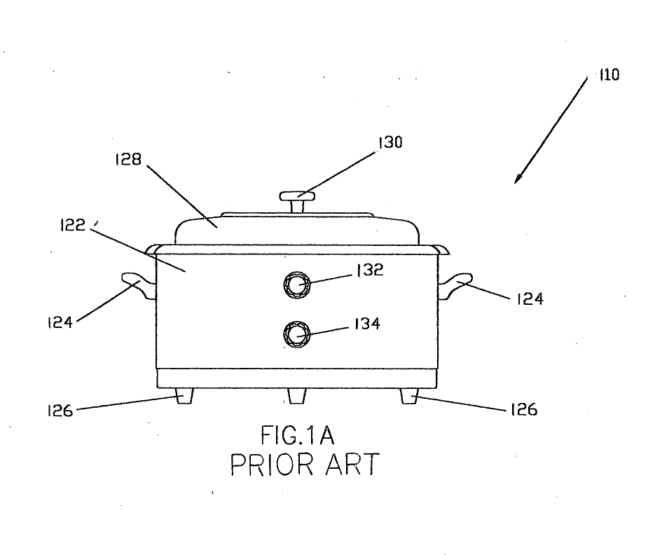

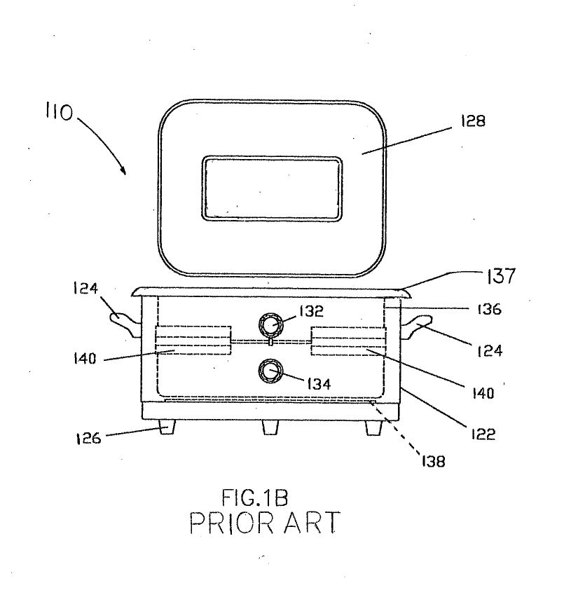

With further reference to the drawings, there is shown therein an embodiment of a prior art roasting oven, indicated generally at 110, and illustrated in FIG. 1A. Roasting oven 110 is comprised of an outer housing 122 equipped with fixed external handles 124 and feet 126. Roasting oven 110 is also provided with a standard lid 128 equipped with a handle 130. In the preferred embodiment the housing 122 is constructed of sheet steel, heat resistant plastic, or other suitable material.

Roasting oven 110 includes an internal heating well 136 having a peripheral flange member 136a disposed within the housing 122 as more clearly shown in FIG. 1B. The heating well 136 is constructed of sheet steel, cast aluminum, cast iron or other suitable material. The prior art oven 110 as depicted features both a wrap-around heating element 140 and a bottom heating element 138. It will be appreciated by those skilled in the art that many prior art roasting ovens have only a wrap-around heating element 140 and, thus, the bottom heating element may be omitted entirely. It will be understood that the present invention can be implemented with either construction.

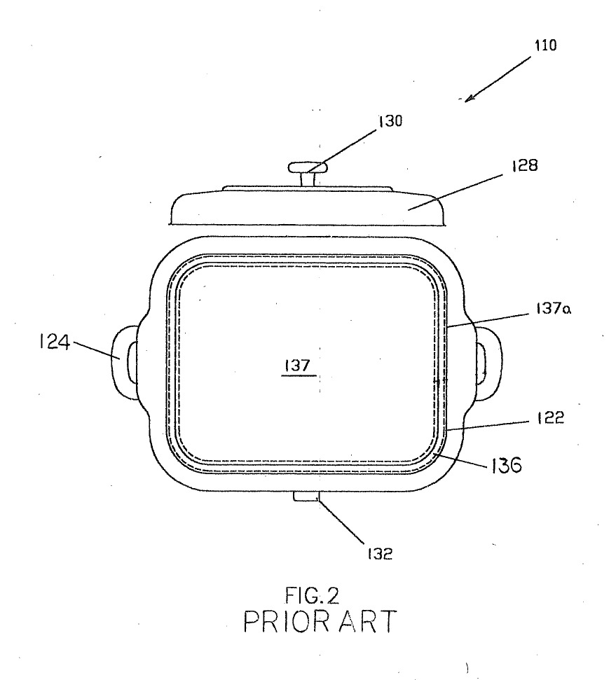

The prior art roasting oven 110 also includes a removable cooking liner 137 (FIG. 2) including a peripheral flange member 137a, which is seated on the upper edge of the housing 122 as shown. The liner 137 is also constructed of stainless steel, enamel-coated steel, cast aluminum, ceramic or other suitable material. Cooking liner 137 is easily removed from the heating well 136 for cleaning.

Referring to the embodiment illustrated in FIG. 2, it can be seen that the prior art roasting oven 110 is rectangular in configuration. It has been determined that optimal heating of the side wall surfaces of a large capacity (i.e. up to 26 quarts) 137 can be achieved at all times in a rectangular configuration. However, it will be appreciated that prior art roasting ovens 110 may be constructed in circular, square, or oval configurations as well.

Referring again to the prior art roasting oven shown in FIG. 1A, temperature and optional function controls are typically provided on a front surface of the housing 122 to carry out the operation of the roasting oven 110. Such controls may include a temperature control switch 134 which is electrically interconnected with both the wrap-around and optional bottom heating elements 140, 138 respectively and serves to regulate the operation thereof. Such controls may also include a cooking mode switch 132 to selectively energize the wrap-around and/or bottom heating elements 140, 138. It is reiterated in alternative embodiments that the bottom heating element 138 may be omitted from the construction depending on the capacity of a given oven 110 and, thus, the temperature and function controls will be modified accordingly.

Alternatively, the prior art roasting oven may utilize an integrated control circuit board that provides the user with digital control of the cooking functions.

The prior art roasting oven 110 is designed for use with standard household electrical systems and is designed to operate in the range of 1000-1500 watts. Of course, this wattage rating varies for a given application and capacity of a prior art roasting oven.

It is known the prior art to provide a top-heating element in a roasting oven. For example, U.S. Pat. No. 7,012,221 to the same inventor discloses such a top-heating element in which a hinged lid member including a top-heating element is attached to the oven by electrically conductive supporting structures that incorporate the electrical circuitry and components for the top-heating element and which provide for convenient disconnection thereof for cleaning and storage. However, the top-heating element disclosed in U.S. Pat. No. 7,012,221 is not designed for stand-alone use in the manner of the present top-browner cooking system and is not adaptable for retrofitting to various prior art roasting ovens which do not include a top-browning element as original equipment.

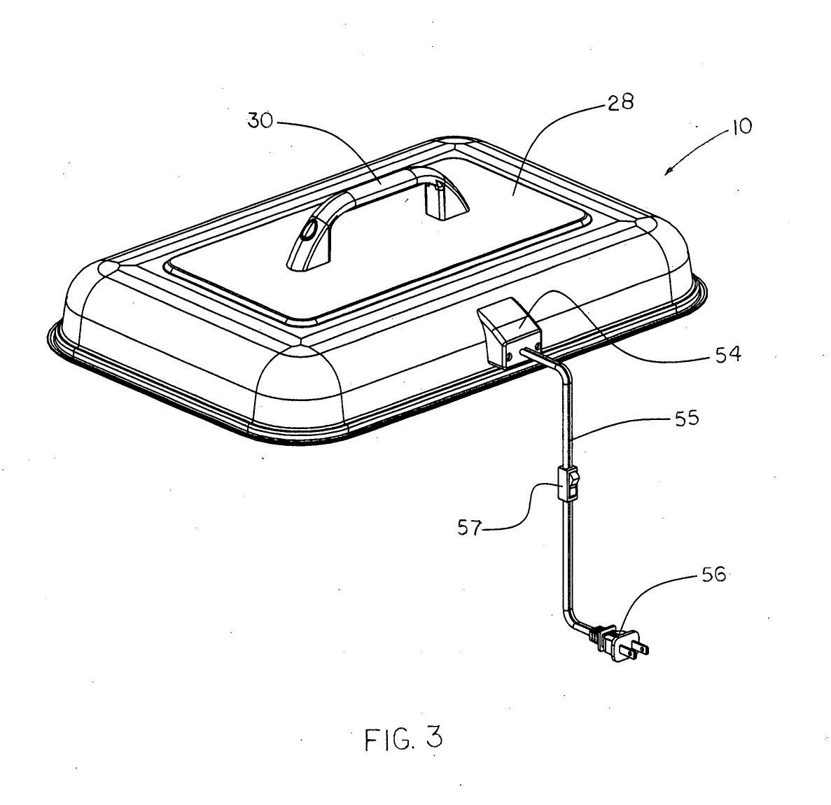

The top-browner cooking system of the present invention will now be described in detail. With further reference to the drawings there is shown therein an embodiment of a top-browner assembly in accordance with the present cooking system, indicated generally at 10 and illustrated in FIG. 3.

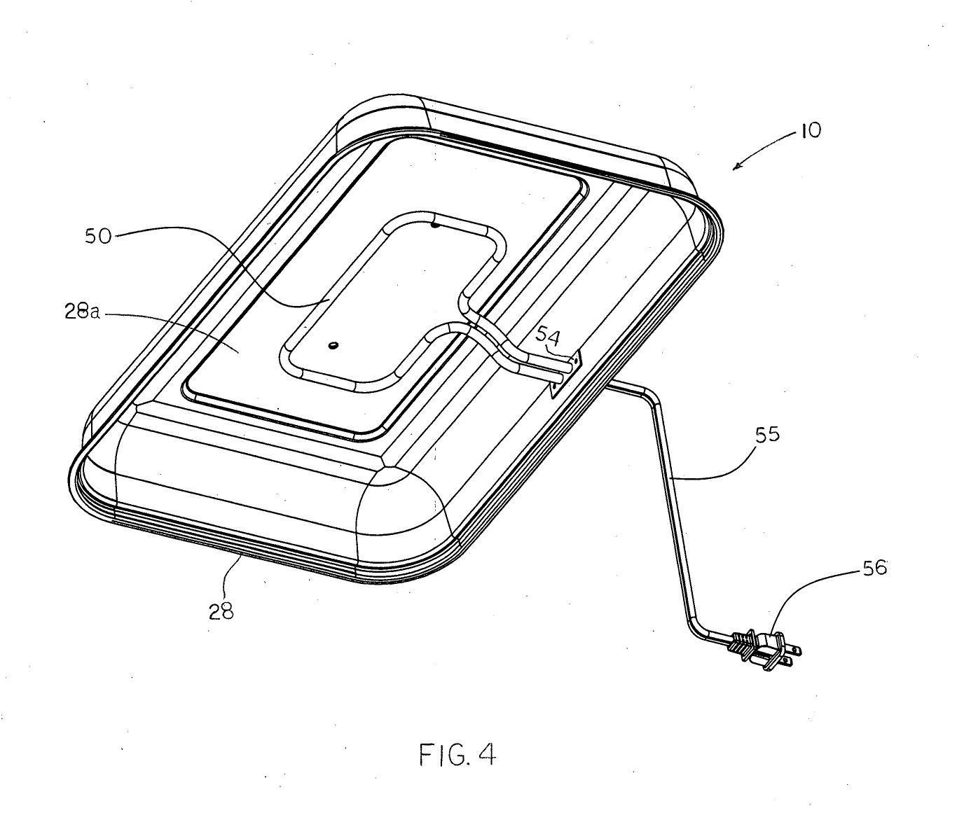

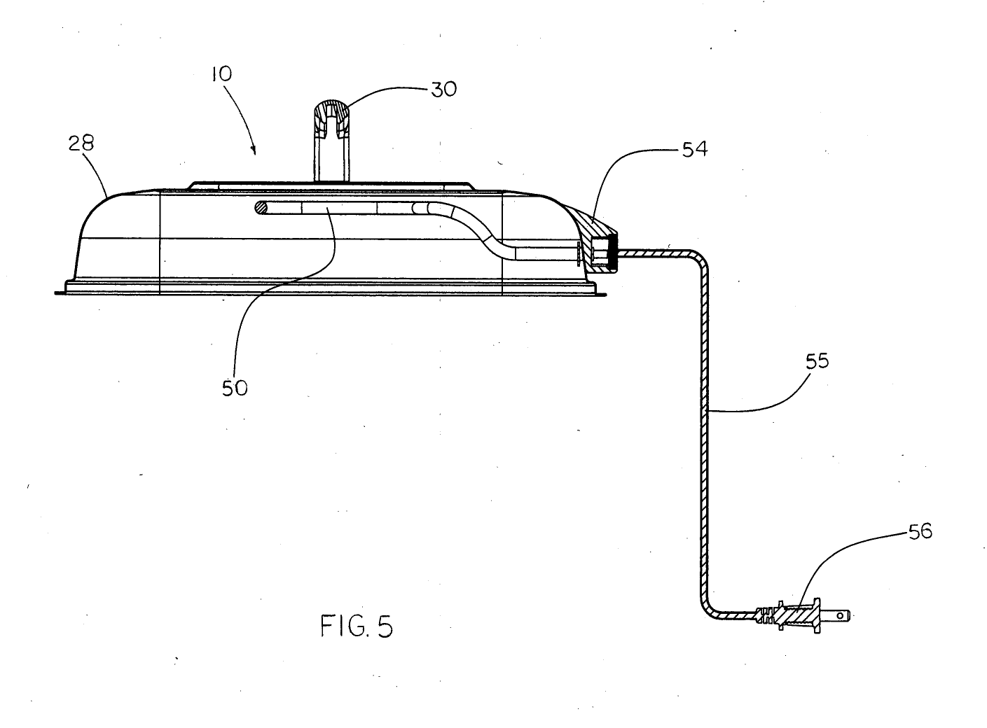

In the embodiment shown in FIG. 3, the present top-browner assembly 10 includes a replacement lid member 28 wherein a tubular type (e.g. CAL-ROD®) browning element 50 having a generally rectangular configuration is mounted on the inner surface 28a (FIG. 4) of the lid 28 as shown. In this embodiment the replacement lid 28 is fabricated from a heat resistant material such as metal, heatproof glass or other suitable material. As most clearly shown in FIG. 5, the browning element 50 extends through the lid member 28 within an insulating block 54 and is electrically connected to a power outlet via power cord 55, which terminates in an electrical plug connector 56.

Power cord 55 may include an electromechanical, single pole-single throw (i.e. ON/OFF) switch 57 to actuate the browning element 50 (FIG. 3). Alternatively, a multi-position (i.e. LOW, MEDIUM, and HIGH) step switch or rheostat type switch (not shown) to control browning temperature is provided for the user's convenience. The present top-browner assembly 10 of the present cooking system is designed to be plugged directly into a 110 volt AC power outlet or, alternatively, can be plugged into an auxiliary AC outlet provided on some brands of prior art roasting ovens. Alternatively, power cord 55 can be constructed to be detached and re-attached from insulating block 54. The present top-browner assembly 10 is designed to operate in the range of 100-300 watts.

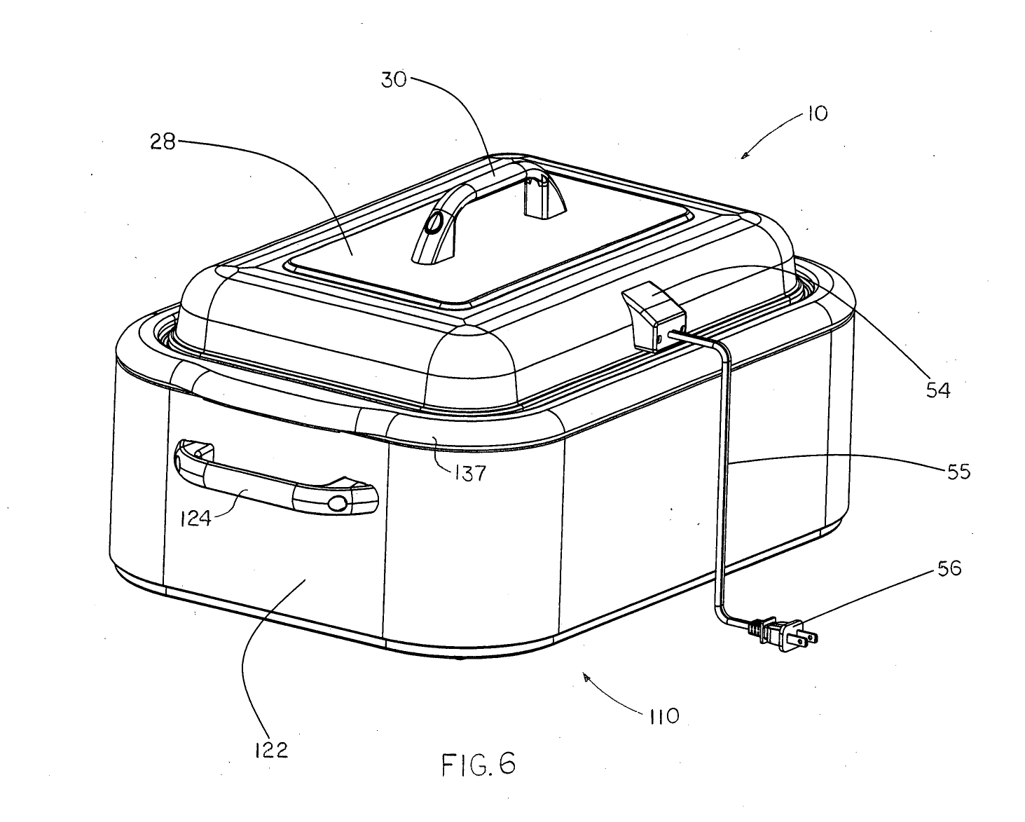

Referring now to FIG. 6, the top-browner assembly 10 of the present cooking system is shown retrofitted on a prior art roasting oven 110, in which the original equipment lid 128 has been removed and the present top-browner assembly 10 including replacement lid 28 has been substituted. It can be seen that in this embodiment the top-browner assembly 10 is designed to closely conform to the rectangular configuration of the preexisting roasting oven 110.

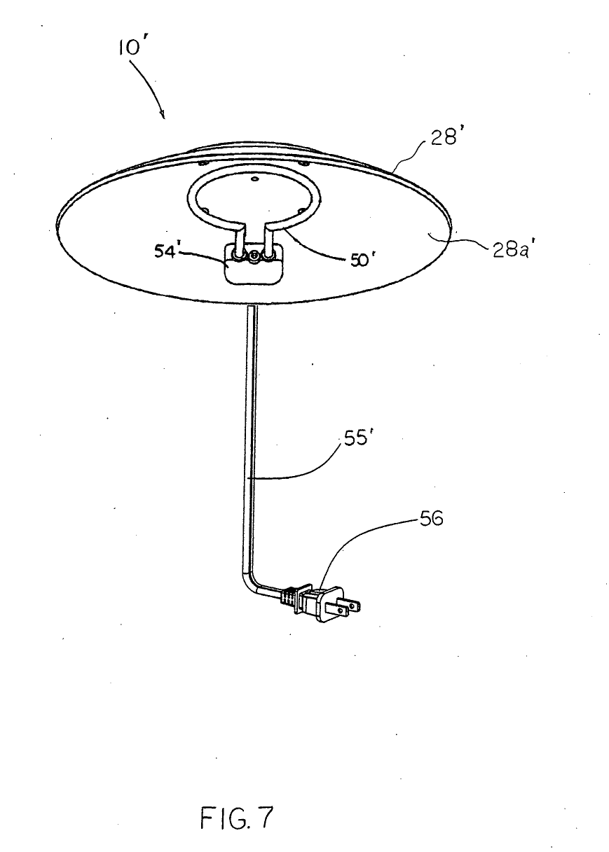

However, it will be understood that a plurality of top-browner assemblies 10, 10′ (FIG. 7) of the present cooking system are provided in a variety of shapes and dimensions to closely conform to commercially available roasting ovens already in use that do not include a top-browning element as original equipment.

Referring now to FIG. 7 there is shown such an alternative embodiment of a top-browner assembly of the present system, indicated generally at 10′. In this embodiment a tubular type (e.g. CAL-ROD®) heating element 50′ of a generally oval configuration is similarly mounted on the inner surface 28a′ of an oval-shaped replacement lid 28′ as shown.

Lid 28′ is similarly fabricated from a heat resistant metal, heatproof glass or other suitable material. Heating element 50′ extends through the lid 28′ within an insulating block 54′ and terminates in a plug connector 56. Top-browning element 50′ is electrically connected to a power outlet via power cord 55, which terminates in an electrical plug connector 56.

Power cord 55′ may optionally include an electromechanical, single pole-single throw (i.e. ON/OFF) switch 57 (FIG. 3) to energize browning element 50′, a multi-step (i.e. LOW, MEDIUM, and HIGH) switch or rheostat type switch (not shown) to control browning temperature is provided for the user's convenience. The present top-browner assembly 10′ of the present cooking system is designed to be plugged directly into a 110 Volt AC power outlet or, alternatively, can be plugged into an auxiliary AC outlet provided on some prior art roasting ovens. Similarly, power cord 55′ can be constructed to be detached and re-attached from insulating block 54′. The present top-browner assembly 10′ is also designed to operate in the range of 130-300 watts.

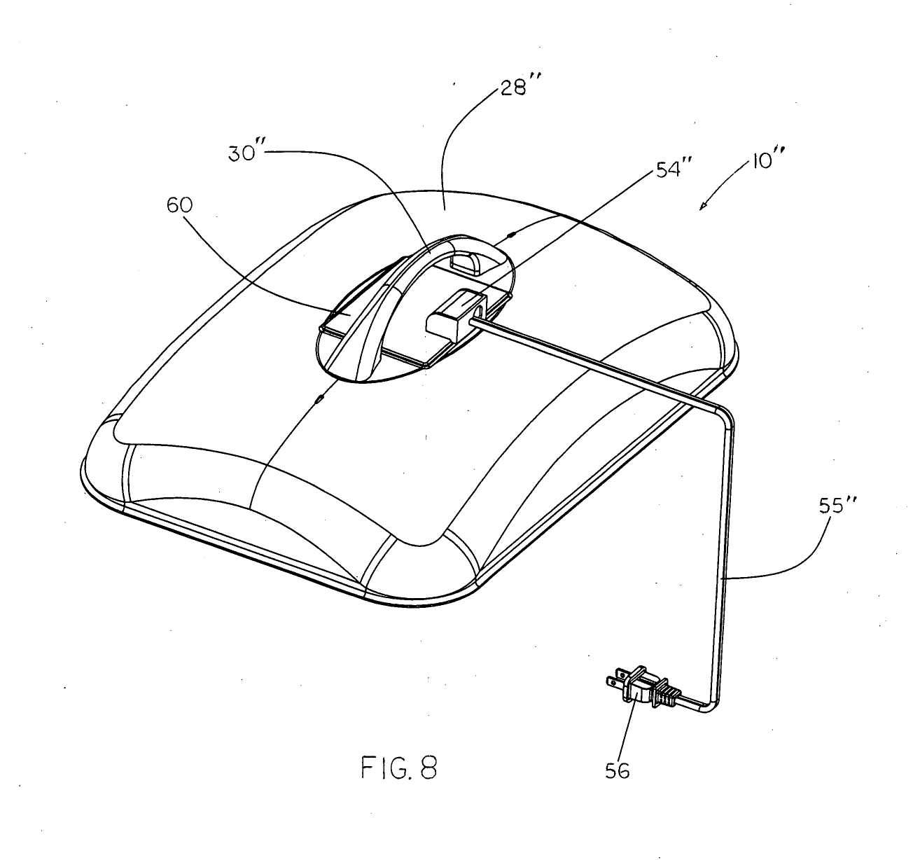

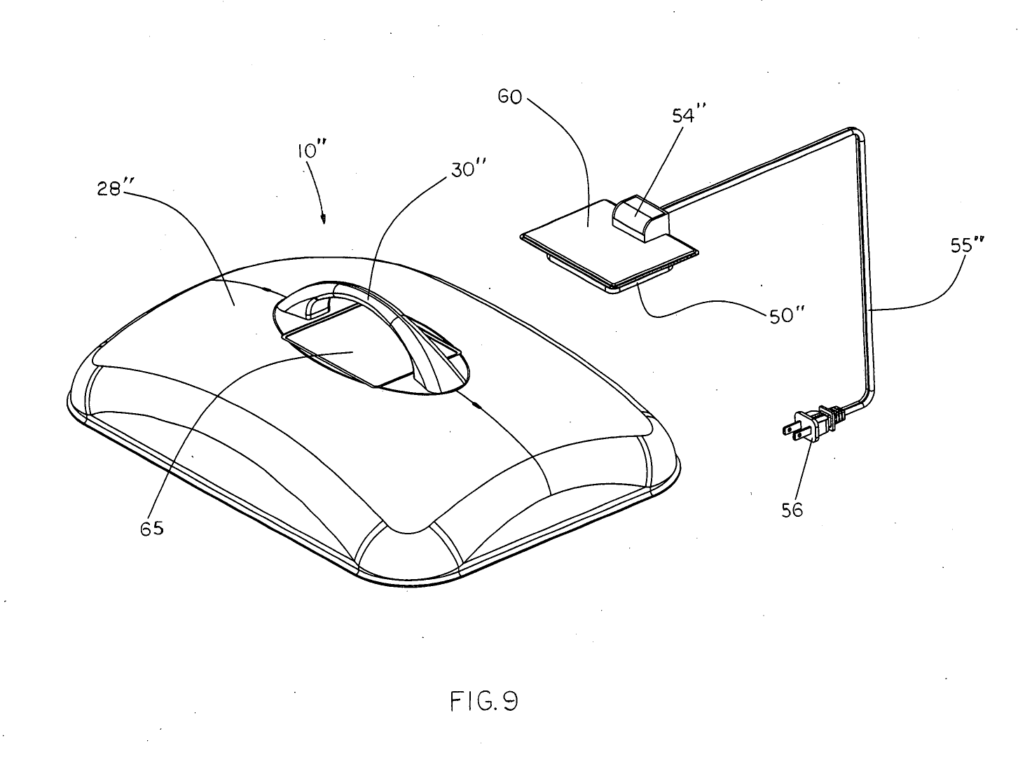

Referring to FIG. 8 there is shown an alternative embodiment of the present top-browner assembly, indicated generally at 10″. In this embodiment a tubular type (e.g. CAL-ROD®) browning element 50″ of a generally square configuration is mounted on the bottom surface of a detachable plate 60 (FIG. 9), which is designed to engage a mating opening or receptacle 65 formed in the top surface of a replacement lid 28″ as shown.

Referring to FIG. 9 it will be understood that top-browner assembly 10″ is easily detached from replacement lid 28″ for the convenience of the user. A blank cover (not shown) conforming to the dimensions of plate 60 is provided for insertion in the opening 65 formed in lid 28″ when top-browner assembly 10″ is removed and the top-browning function is not required.

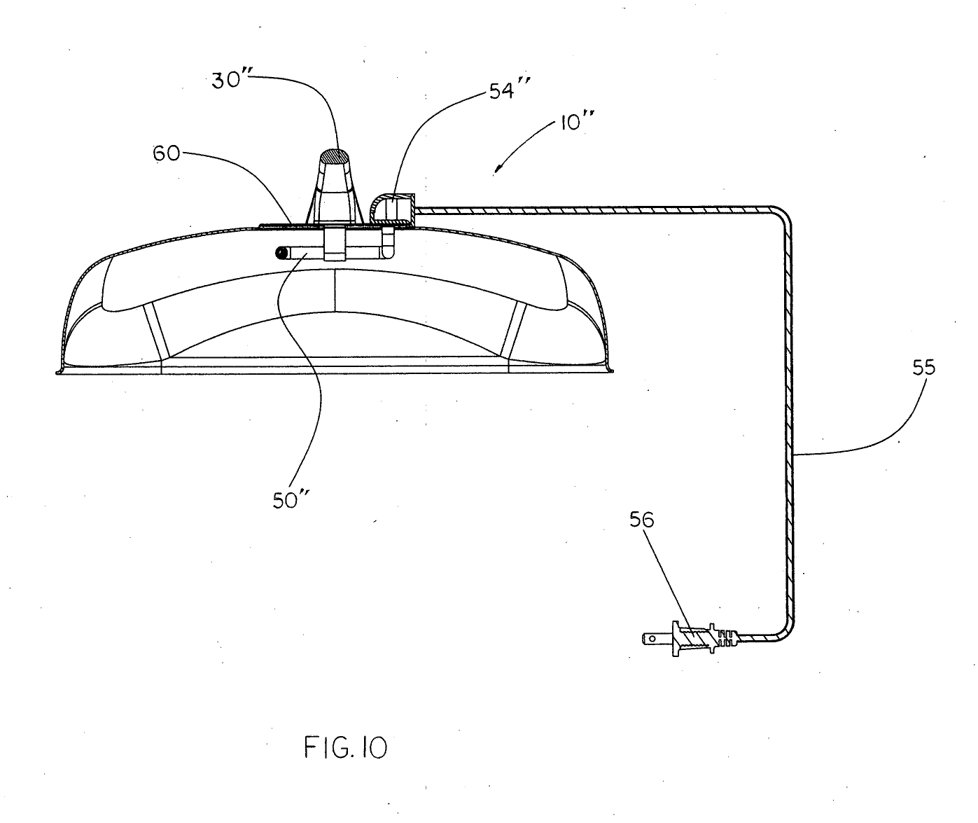

Lid 28″ is also fabricated from a heat resistant material such as heatproof glass, metal or other suitable material. Browning element 50″ extends through the plate 60 within an insulating block 54″ and terminates in a plug connector 56 as shown in FIG. 10. Top browning element 50″ is also electrically connected to a power outlet via power cord 55, which terminates in an electrical plug connector 56.

Power cord 55″ may also include an electromechanical ON/OFF switch 57 (FIG. 3) to energize the browning element 50″. Alternatively, a multi-step (i.e. LOW, MEDIUM, and HIGH) switch or rheostat (not shown) is provided to control browning temperature for the user's convenience. The top-browner assembly 10″ of the present cooking system is also designed to be plugged directly into a 110 volt AC power outlet or, alternatively, can be plugged into an auxiliary AC outlet provided on some brands of roasting ovens. Similarly, power cord 55″ can be constructed to be detached and re-attached from insulating block 54″. Top-browner assembly 10″ is also designed to operate in the range of 100-300 watts.

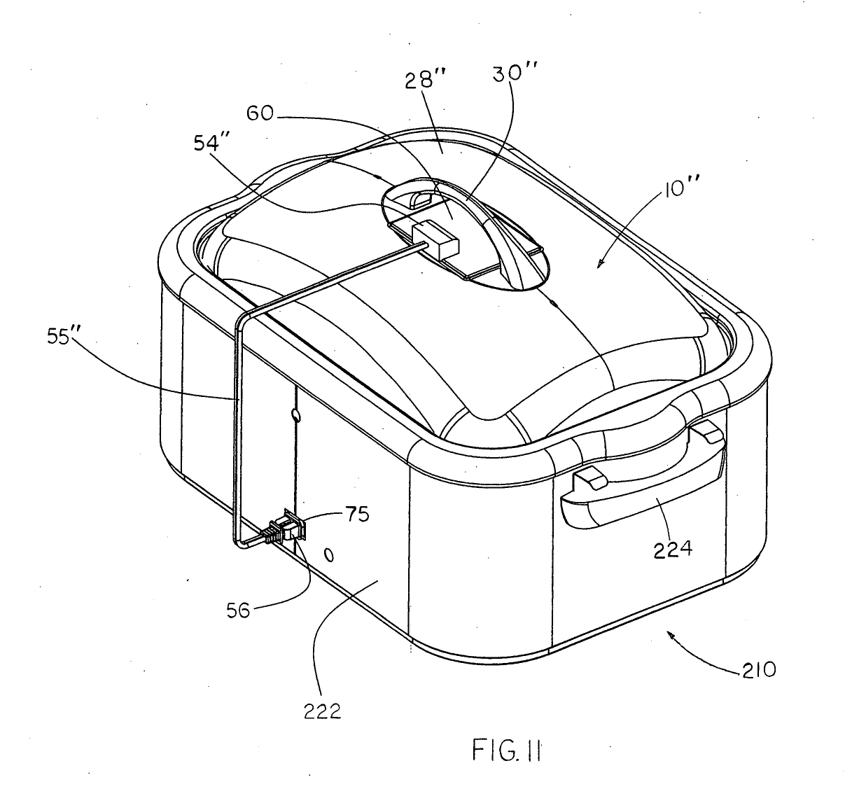

In accordance with the present invention, it is contemplated that the detachable top-browner assembly 10″ of the present top-browner cooking system described hereinabove will be utilized in combination with roasting ovens of new construction in addition to retrofitting prior art roasting ovens already in use. With reference to FIG. 11 there is shown a detachable top-browner assembly 10″ as shown in FIG. 8 installed on an electric roasting oven of new construction, indicated generally at 210. Roasting oven 210 is generally similar in construction to the prior art roasting oven 110 described hereinabove.

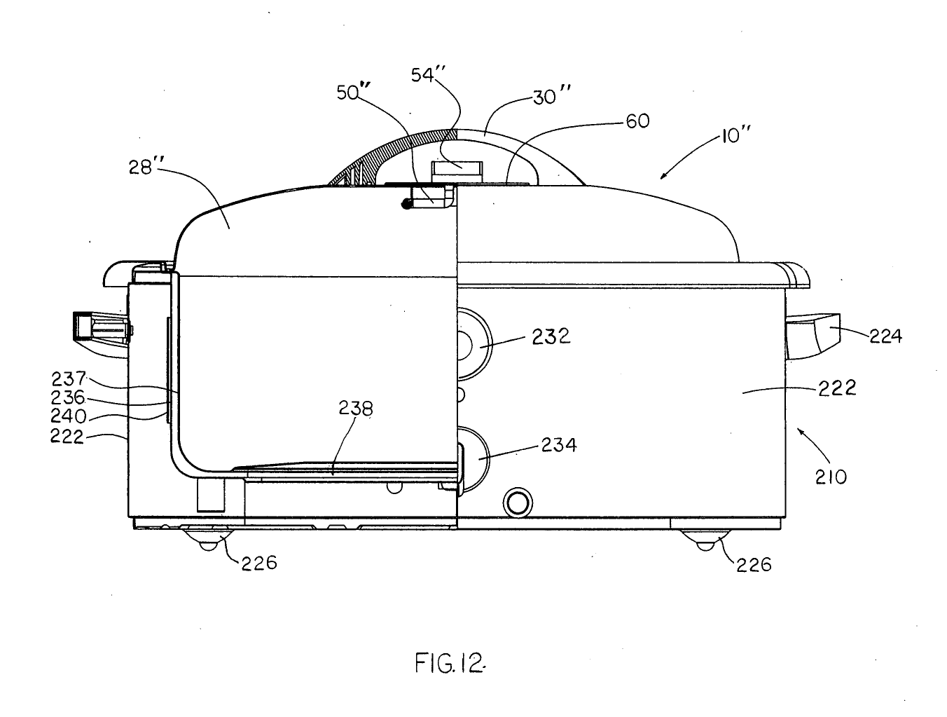

Roasting oven 210 is comprised of an outer housing 222 equipped with fixed external handles 224 and feet 226 (FIG. 12). In the preferred embodiment the housing 222 is constructed of sheet steel, heat resistant plastic, or other suitable material.

Roasting oven 210 includes an internal heating well 236 (FIG. 12) having a removable cooking liner 237 disposed within the internal heating well 236 as most clearly shown in FIG. 12. The heating well 236 is constructed of sheet steel, cast aluminum, cast iron, ceramic or other suitable material. Oven 210 as depicted in FIG. 12 features both a wrap-around heating element 240 and an optional bottom heating element 238.

Roasting oven 210 also includes a removable cooking liner 237 (FIG. 12) which is seated on the upper edge of the housing 222 as shown. Liner 237 is similarly constructed of stainless steel, enamel-coated steel, cast aluminum or other suitable material. Cooking liner 237 is easily removed from the heating well 236 for cleaning.

Still referring to the embodiment illustrated in FIG. 12, it can be seen that roasting oven 210 is rectangular in configuration. It has been determined that optimal heating of the side wall surfaces of a large capacity (i.e. up to 26 quarts) cooking liner 237 can be achieved at all times in a rectangular configuration. However, it will be appreciated that oven 210 may be constructed in circular, square, or oval configurations.

The temperature and function controls for oven 210 are provided on a front surface of the housing 222 to carry out the operation of the roasting oven 210. Such controls may include a temperature control switch 234 which is electrically interconnected with the wrap-around and optional bottom heating elements 240, 238 respectively and serve to regulate the operation thereof. Such controls may also include an optional cooking mode switch 232 to selectively energize the wrap-around and/or bottom heating elements 240, 238. In alternative embodiments the bottom heating element 238 may be entirely omitted from the construction depending on the capacity of a given roasting oven and the temperature and function controls modified accordingly.

In another alternative embodiment roasting oven 210 may include an integrated control circuit board that provides the user with digital control of the cooking functions. Roasting oven 210 is designed for use with standard 110 volt AC electrical systems and is designed to operate in the range of 100-1600 watts. This wattage rating varies for a given application and capacity of roasting oven 210.

Power cord 55″ (FIG. 11) may include an electromechanical, single pole-single throw (i.e. ON/OFF) switch 57 to actuate the browning element 50″. Alternatively, a multi-position (i.e. LOW, MEDIUM, and HIGH) step switch or rheostat type switch (not shown) to control browning temperature is provided for the user's convenience.

The top-browner assembly 10″ of the present cooking system is designed to be plugged directly into a 110 volt AC power outlet or, alternatively, can be plugged directly into an auxiliary AC outlet 75 (FIG. 11) having internal circuitry and supporting structure at the rear surface of roasting oven 210.

Roasting oven 210 is designed for use with standard 110 volt AC electrical systems and is designed to operate in the range of 1000-1500 watts. This wattage rating varies for a given application and capacity of a prior art roasting oven.

In summary, the present invention has been developed to provide a top-browner cooking system and method of use for roasting ovens which do not include a top-browning element as original equipment. The present top-browner cooking system provides a plurality of top-browner assemblies in a various configurations and dimensions for retrofitting to commercially available prior art roasting ovens such as those manufactured under the trade names, CROCK POT®, RIVAL®, CUISINART® and other brands. The detachable top-browner assembly of the present top-browner cooking system described hereinabove will also be utilized in combination with roasting ovens of new construction in addition to retrofitting prior art roasting ovens already in use.

Although not specifically illustrated in the drawings, it should be understood that additional equipment and structural components will be provided as necessary, and that all of the components described above are arranged and supported in an appropriate fashion to form a complete and operative top-browner cooking system for electric roasting ovens incorporating features of the present invention. It is also understood that variations may be made in the present invention without departing from the scope of the invention.

Moreover, although illustrative embodiments of the invention have been described, a latitude of modification, change, and substitution is intended in the foregoing disclosure, and in certain instances, some features of the invention will be employed without a corresponding use of other features. Accordingly, it is appropriate that the appended claims be construed broadly and consistent with the scope of the invention.

What is claimed is:

1. A top-browner cooking system for use in combination with an electric roasting oven, said top-browner cooking system comprising:
a plurality of top-browner assemblies conforming dimensionally to preexisting roasting ovens, wherein each of said top-browner assemblies further comprises a replacement lid member, a top-browner cooking element mounted on an inner surface of said replacement lid member, wherein said top-browner cooking element extends through said lid member within an insulating block installed in said lid member; and
a power cord electrically connected to said top-browner cooking element at a juncture with said insulating block.

2. The top-browner cooking system of claim 1 wherein said top-browner cooking elements are tubular type heating elements.

3. The top-browner cooking system of claim 1 wherein said power cord terminates in a standard electrical plug.

4. The top-browner cooking system of claim 3 wherein said power cord includes an electromechanical power switch.

5. The top-browner cooking system of claim 3 wherein said power switch is a multi-position power switch.

6. The top-browner cooking system of claim 2 wherein said replacement lid member is rectangular in configuration.

7. The top-browner cooking system of claim 2 wherein said replacement lid member is oval in configuration.

8. The top-browner cooking system of claim 1 wherein said insulating block is mounted on a removable plate installed within said replacement lid member.

9. A deep well cooker comprising:
an outer housing having a lid member including an opening formed therein;
a detachable top-browner assembly mounted on a plate member, wherein said plate member closely conforms to said opening in said lid member for installation therein;
a deep well member disposed within said housing, said deep well member having a bottom surface with integrally formed sidewalls and an open top;
a wrap-around heating element radially disposed about said deep well member and positioned intermediate said housing and said deep well member; and
a temperature controller electrically interconnected to said wrap-around heating element for regulating the temperature thereof.

10. The deep well cooker of claim 9 wherein said deep well cooker further includes a bottom heating element electrically interconnected to said temperature controller, wherein said deep well cooker further includes a function controller electrically interconnected to said temperature controller enabling said bottom heating element and said wrap-around heating element to be selectively energized using said function controller to provide variable cooking modes.

11. The deep well cooker of claim 9 wherein said lid member is rectangular in configuration.

12. The deep well cooker of claim 9 wherein said lid member is oval in configuration.

13. The deep well cooker of claim 9 wherein said deep well cooker further includes a removable cooking liner.

14. The deep well cooker of claim 9 wherein said detachable top-browner assembly includes a top browning element extending through said plate member within an insulating block installed therein.

15. The deep well cooker of claim 14 wherein said detachable top-browner assembly includes a power cord electrically connected to said top-browning element at a juncture with said insulating block, wherein said power cord terminates in an electrical plug.

16. The deep well cooker of claim 15 wherein said power cord further includes an electromechanical switch installed therein.

17. A method of retrofitting an electric roasting oven having an original equipment lid lacking top-browning capability with a top-browner cooking system, said method comprising the steps of:
providing a top-browner cooking system including a plurality of top-browner assemblies each having a replacement lid member, a top-browner cooking element and a power cord electrically connected to said cooking element;
removing the original equipment lid from said electric roasting oven;
selecting one of said plurality of top-browner assemblies closely conforming to the dimensions of said original equipment lid;
installing said one of said plurality of top-browner assemblies on said roasting oven; and
energizing said top-browner cooking element.

18. The method of claim 17 further including the step of:
inserting a detachable top-browner assembly into one of said replacement lid members having a receptacle formed therein.

19. The method of claim 17 wherein the step of energizing is carried out by an electromechanical power switch installed in said power cord.

20. The method of claim 17 wherein the step of installing further includes the step of:
detachably engaging said power cord from said top-browner cooking element.
